(19) United States
(12) Patent Application Publication
(10) Pub. No.: US 2019/0219987 A1
(43) Pub. Date: Jul. 18, 2019

(54) CNC MACHINING APPARATUS

(71) Applicant: Nitin KELKAR, Maharashtra (IN)

(72) Inventor: Nitin KELKAR, Maharashtra (IN)

(21) Appl. No.: 16/324,546

(22) PCT Filed: Aug. 8, 2017
(86) PCT No.: PCT/IN2017/050327

§ 371 Date: Feb. 8, 2019

(30) Foreign Application Priority Data
Aug. 12, 2016 (IN) 201621016623

(51) Int. Cl. G05B 19/414; B23Q 1/48

(52) U.S. Cl. CPC G05B 19/4145; B23Q 1/489

(57) ABSTRACT

Disclosed is a CNC machining apparatus (100). The CNC machining apparatus (100) comprises a first moving plate (40) configured in X axis on a stationary base (30), a second moving plate (50) mounted in Y axis on an upper portion of a support member (20), a third moving plate (60) mounted in Z axis on the second moving plate (50). The third moving plate (60) includes having a spindle (55) mounted thereon, wherein the spindle (55) includes a cutting tool (53) configured therein. The CNC machining apparatus (100) also comprises a fourth moving frame (70) configured in A axis on the first moving plate (40), a fifth moving frame (80) configured in B axis on the Z axis moving plate (60), and a sixth moving frame (90) configured in Z1 axis in the B axis plate (80). The spindle (55) moves vertically up and down on Z axis, swings around B axis pivot and also moves up and down in Z1 axis that is mounted on B axis.

### FIELD OF THE INVENTION

The present invention relates to a machining apparatus and more particularly, to CNC machining apparatus.

### BACKGROUND OF THE INVENTION

The traditional machines for processing of a job are operated manually and hence, the precision of the job depends on the skills and expertise of an operator. To minimize the role of the operators, computer numerical control (herein after “CNC”) machines are developed. The CNC machine comprises a computer in which the operator has to merely feed the program of instructions for cutting the job as per the requirements, load the required tools in the machine and rest of the work is done by the computer automatically. Typical CNC machines support translation in two or three axes. Recent advancements in technology have led to the development of five-axis CNC machines.

Presently available five-axis CNC machines are designed to mount A and B axes on a table that moves in X axis. When processing smaller job components such as a watch case, small impeller, jewelry components or dental bridges that have a size of 100 mm or even smaller, the construction of X axis with the moving table becomes a non-essential part and unnecessarily increases the size and weight of the machine thereby making the machine quite bulky. Further, these designs use higher capacity Linear Motion Guides (LMGs) and ball screws for moving the table thereby increasing the cost of construction and that of the machine.

Many attempts have been made in the past to design a compact five-axis CNC machine especially for holding and processing smaller job components. However, such attempts have resulted in reducing the strength and rigidity of the CNC machines rendering the machines ineffective for processing of metallic jobs.

Indian Patent application 4099/MUM/2013 discloses a compact five axis CNC machine. The five axis machining apparatus is designed to hold together A, C and X axes thereby resulting in a reduced size without compromising on rigidity that is required for processing metallic job components. The five axis machining apparatus (100) allows independent as well as simultaneous control of X, Y, Z, A and C axes.

However, in all such CNC machines where the spindle gets swinging motion, the CNC controller must have the RTCP (Rotation Tool Centre Point) function to allow the tool length compensation in space. In five axis machine configuration, wherein the spindle is given a swinging motion, it is necessary to know the distance between the bottom of the tool and the centre of the rotary head of the tool. This distance is called pivot length. According to the value of this length and value of rotation of the axes, one have to calculate linear value XYZ of compensation in order to maintain the centre of the tool in the desired position. Further, in the five axis machine configuration of the prior art wherein the spindle is given a swinging motion, it is not possible to remove the machining tool at an angle from the job. When the tool is machining the job at an angle and if power is lost suddenly, it is not possible to remove the machining tool from the job without damaging the job or the tool.

Accordingly, there exists a need of a CNC machining apparatus that overcomes the drawbacks of the prior art.

### OBJECT OF THE INVENTION

An object of the present invention is to provide a CNC machining apparatus that is easily mountable on a table for holding and processing smaller job components.

Yet another object of the present invention is to remove the tool from a job at an angle without damaging the job or the tool.

### SUMMARY OF THE INVENTION

Accordingly, the present invention provides a CNC machining apparatus (100). The CNC machining apparatus (100) comprises a base member (10), a support member (20) extending vertically from one end of the base member (10), and a stationary base (30) mounted in X axis on top of the base member (10). The CNC machining apparatus (100) further comprises a first moving plate (40) configured in X axis on the stationary base (30). The first moving plate (40) is capable of being driven by a first driving mechanism. The CNC machining apparatus (100) furthermore comprises a second moving plate (50) mounted in Y axis on an upper portion of the support member (20). The second moving plate (50) is capable of being driven by a second driving mechanism. The CNC machining apparatus (100) moreover comprises a third moving plate (60) mounted in Z axis on the second moving plate (50). The third moving plate (60) is capable of being driven by a third driving mechanism. The third moving plate (60) also includes a spindle (55) mounted thereon, wherein the spindle (55) includes a cutting tool (53) configured therein.

The CNC machining apparatus (100) also comprises a fourth moving frame (70) configured in A axis on the first moving plate (40). The fourth moving frame (70) is adapted for being driven in response to the movement of the first moving plate (40).

The CNC machining apparatus (100) further comprises a fifth moving frame (80) configured in B axis on the Z axis moving plate (60), a sixth moving frame (90) configured in Z1 axis in the B axis plate (80). The spindle (55) moves vertically up and down on Z axis, swings around B axis pivot and also moves up and down in Z1 axis that is mounted on B axis

Finally, the CNC machining apparatus (100) comprises a controller for controlling the movements of the first moving plate (40), the second moving plate (50), the third moving plate (60), fourth moving frame (70), fifth moving frame (80) and a sixth moving frame (90).

### BRIEF DESCRIPTION OF THE DRAWINGS

The objectives and advantages of the present invention will become apparent from the following description read in accordance with the accompanying drawings wherein,

FIG. 1 shows isometric view of a CNC machining apparatus, in accordance with the present invention;

FIGS. 2 and 3 shows another isometric view of the CNC machining apparatus of FIG. 1.

FIGS. 4 and 4A shows a CNC machining apparatus, in accordance with an embodiment of the present invention;

FIG. 5 shows a CNC machining apparatus, in accordance with another embodiment of the present invention; and

FIG. 6 shows a CNC machining apparatus, in accordance with a yet another embodiment of the present invention.

### DETAILED DESCRIPTION OF THE INVENTION

The foregoing objects of the invention are accomplished and the problems and shortcomings associated with the prior art techniques and approaches are overcome by the present invention as described below in the preferred embodiment.

The present invention provides a CNC machining apparatus that is easily mountable on a table for holding and processing smaller job components. However, it may be evident to those in skilled in the art that the CNC machining apparatus of the present invention can be suitably modified for machining the job components of desired size. The CNC machining apparatus allows independent as well as simultaneous control of five axes during processing of the jobs. Further, the CNC machining removes the tool from a job at an angle without damaging the job or the tool.

This present invention is illustrated with reference to the accompanying drawings, throughout which reference numbers indicate corresponding parts in the various figures. These reference numbers are shown in bracket in the following description.

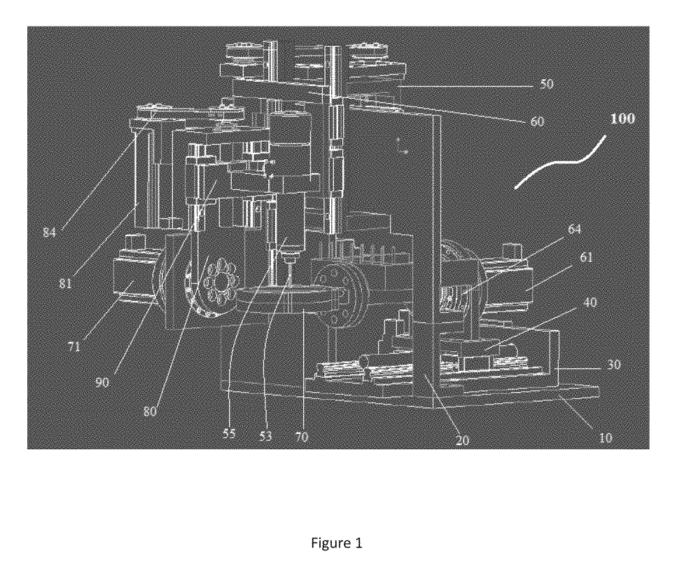

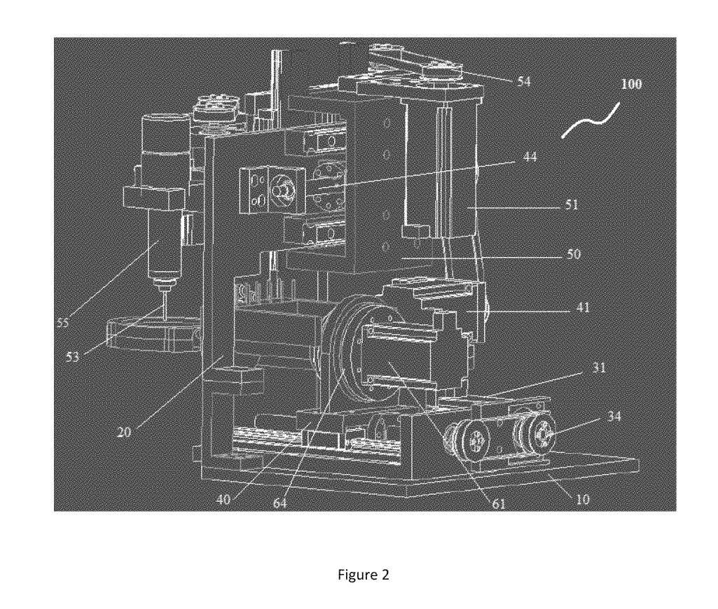

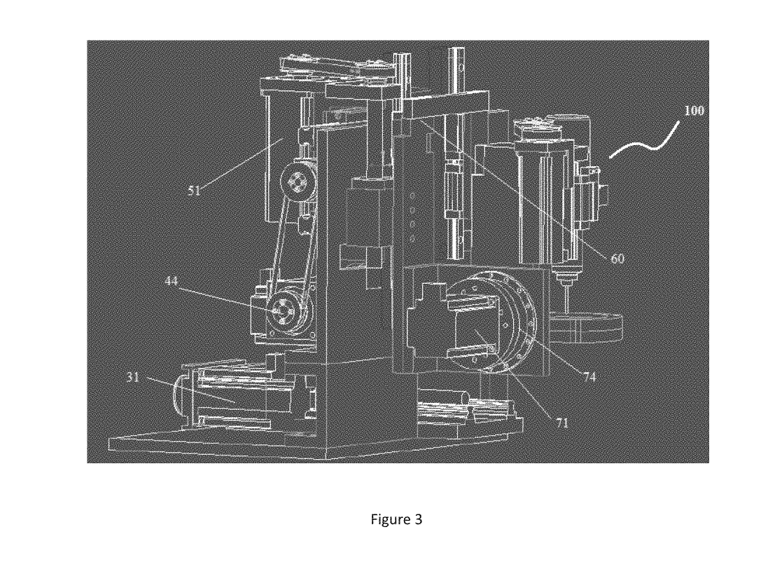

Referring now to FIGS. 1, 2 and 3 a CNC machining apparatus (100) (hereinafter “the apparatus (100)”) in accordance with the present invention is shown. The apparatus (100) operates by allowing movements in X, Y, Z, A, B and Z1 axes. The apparatus (100) comprises a base member (10), a support member (20), a stationary base (30), a first moving plate (40), a second moving plate (50), a third moving plate (60), a fourth moving frame (70), a fifth moving frame (80), a sixth moving frame (90) and a controller (not shown).

Specifically, the above mentioned parts of the apparatus (100) are made from metallic components. However, it is understood that the above mentioned parts of the apparatus (100) of varying shapes and dimensions can be made from any suitable materials known in the art. The apparatus (100) is capable of being suitably modified in accordance with various alternate embodiments of the present invention to comprise an automatic tool changer, an automatic lubrication system, a dust collection system, a mist cooling system and the like.

The base member (10) includes the support member (20) extending vertically from one end (not numbered) thereof and the stationary base (30) mounted thereon. Specifically, the stationary base (30) is mounted in X axis on top of the base member (10).

The first moving plate (40) is configured in X axis on the stationary base (30). The first moving plate (40) is capable of being driven by a first driving mechanism. The first driving mechanism is positioned between the first moving plate (40) and the stationary base (30). The first driving mechanism includes a first motor (31) and a first driving unit (34) connected thereto. The first motor (31) is selected from any of rotary motors, linear motors and any other types of digital positioning motors known in the art. The rotary motors are selected from but not limited to a group consisting of servo motors, steppers, micro steppers, rotary digital positioning motors and the like. Preferably, the first driving unit (34) consists of at least one timing belt and at least one pulley. However, the first driving unit can also be selected from but not limited to a group consisting of a harmonic drive, a cycloid drive, a worm wheel gear box, a worm wheel and shaft unit and the like. In one more embodiment, the first motor (31) can also be connected directly to the ball screws using couplings or any other means for driving the ball screws.

The second moving plate (50) is mounted in Y axis on an upper portion (not numbered) of the support member (20). The second moving plate (50) is capable of being driven by a second driving mechanism. The second driving mechanism includes a second motor (41) and a second driving unit (44) connected thereto. The second motor (41) is selected from any of rotary motors, linear motors and any other types of digital positioning motors known in the art. The rotary motors are selected from but not limited to a group consisting of servo motors, steppers, micro steppers, rotary digital positioning motors and the like. Preferably, the second driving unit (44) consists of at least one timing belt and at least one pulley. However, the second driving unit (44) can also be selected from but not limited to a group consisting of a harmonic drive, a cycloid drive, a worm wheel gear box, a worm wheel and shaft unit and the like. In one more embodiment, the second motor can also be connected directly to the ball screws using couplings or any other means for driving the ball screws.

In an embodiment, the second moving plate (50) is mounted in Y axis on the support member (20) perpendicular thereto.

The third moving plate (60) is mounted in Z axis on the second moving plate (50) in Y axis perpendicular to the Z axis. The third moving plate (60) is capable of being driven by a third driving mechanism. The third driving mechanism includes a third motor (51) and a third driving unit (54) connected thereto. The third motor (51) is selected from any of rotary motors, linear motors and any other types of digital positioning motors known in the art. The rotary motors are selected from but not limited to a group consisting of servo motors, steppers, micro steppers, rotary digital positioning motors and the like. Preferably the third driving unit (54) consists of at least one timing belt and at least one pulley. However, the third driving unit (54) can also be selected from but not limited to a group consisting of a harmonic drive, a cycloid drive, a worm wheel gear box, a worm wheel and shaft unit and the like. In one more embodiment, the third motor (51) can also be connected directly to the ball screws using couplings or any other means for driving the ball screws.

The third moving plate (60) includes a spindle (55) mounted thereon. The spindle (55) includes a cutting tool (53) (herein after ‘the tool (53)’) configured therein for processing of a work piece/job (not numbered) (herein after ‘the job’). In an embodiment, the job is selected from a watch case, an impeller, jewelry, dental bridges and the like. The spindle (55) undergoes linear vertical movement when the third moving plate (60) is driven by the third driving mechanism. The spindle (55) undergoes linear horizontal movement when the second moving plate (50) is driven by the second driving mechanism. The spindle (55) moves linearly for positioning the tool (53) at different locations on the job. In an embodiment, the spindle (55) rotates at 24000 revolutions per minute (RPM) or even at higher RPMs to move the tool (53) independently or simultaneously on the Z-axis and the Y axis. The tool (53) undergoes linear up and down movement on the Z-axis to come in or out of contact with the job. The tool (53) undergoes left and right movements on the Y axis to machine the job.

Furthermore, the first moving plate (40), the second moving plate (50) and the third moving plate (60) on either side (not numbered) are configured with linear motion rail (not numbered) (herein after ‘the LM rails’) for undergoing smooth rigid motion. In alternate embodiments of the present invention, the smooth rigid motion of the plates (40, 50, and 60) can be achieved by a bush, a dovetail, a roller guide or any other suitable means known in the art.

The fourth moving frame (70) is configured in A axis on the first moving plate (40) that in turn is configured in X axis. The fourth moving frame (70) is capable of being driven in X axis in response to the movement of the first moving plate (40) in X axis upon being driven by the first driving mechanism. The fourth moving frame (70) is capable of holding the job to be machined therein. The job to be machined is held on the fourth moving frame (70) by anyone of magnetic chuck, jaw chuck, fixture and the like. The size of the job held in the fourth moving frame (70) may vary and not limited to any specific size or dimension.

The fourth moving frame (70) comprises a fourth driving mechanism. The fourth driving mechanism includes a fourth motor (61) and a fourth driving unit (64). The fourth motor (61) is selected from any of rotary motors and any other types of digital positioning motors known in the art. The rotary motors are selected from but not limited to a group consisting of servo motors, steppers, micro steppers, rotary digital positioning motors and the like. Preferably, the fourth driving unit (64) is a worm wheel and shaft unit. However, it is understood that the fourth driving unit can also be selected from but not limited to a group consisting of a harmonic drive, a cycloid drive, a worm wheel gear box, a timing belt and pulley and the like.

The fifth moving frame (80) is configured in B axis on the Z axis moving plate (60). The fifth moving frame (80) comprises a fifth driving mechanism. The fifth driving mechanism includes a fifth motor (71) and a fifth driving unit (74). The fifth motor (71) is selected from any of rotary motors and any other types of digital positioning motors known in the art. The rotary motors are selected from but not limited to a group consisting of servo motors, steppers, micro steppers, rotary digital positioning motors and the like. Preferably, the fifth driving unit (74) is a worm wheel and shaft unit. However, it is understood that the fifth driving unit can also be selected from but not limited to a group consisting of a harmonic drive, a cycloid drive, a worm wheel gear box, a timing belt and pulley and the like.

Further, a sixth moving frame (90) is configured in Z1 axis on the B axis plate (80). The sixth moving frame (90) comprises a sixth driving mechanism. The sixth driving mechanism includes a sixth motor (81) and a sixth driving unit (84). The sixth motor (81) is selected from any of rotary motors and any other types of digital positioning motors known in the art. The rotary motors are selected from but not limited to a group consisting of servo motors, steppers, micro steppers, rotary digital positioning motors and the like. Preferably, the sixth driving unit (84) is a worm wheel and shaft unit. However, it is understood that the sixth driving unit can also be selected from but not limited to a group consisting of a harmonic drive, a cycloid drive, a worm wheel gear box, a timing belt and pulley and the like.

Specifically, the spindle moves vertically up and down in Z axis (60) swings around B axis (80) pivot and also moves up and down in Z1 axis (90) that is mounted on B axis (80).

The controller is configured for controlling the movements of the first moving plate (40), the second moving plate (50), the third moving plate (60), the fourth moving frame (70), the fifth moving frame (80) and a sixth moving frame (90). In a preferred embodiment, the controller is a computer numerical control (CNC) controller.

In all such CNC machines where the spindle (55) gets swinging motion, the CNC controller must have the RTCP (Rotation Tool Centre Point) function. It allows the tool length compensation in space. However, not all CNC controllers available in the market have the RTCP functionality. The CNC machine of the present invention can run with CNC controllers that do not have RTCP function.

Specifically, the value of pivot length is fed in the processor. After every tool change, and with the help of Z zero setter, the controller understands tool bottom distance from the pivot point. Now any deviation in this distance with the hard coded distance will be adjusted by moving the Z1 axis (90) mounted on the B axis (80). During the cutting cycle, the Z1 axis (90) remains dormant and the Z axis (60) becomes active to give tool vertical motion in the Z axis.

In the event of accidental power failure and when the tool (53) is stuck inside the job cavity, the Z1 axis (90) becomes very useful to take out the tool from the cavity, at an angle, without breaking the tool or without damaging the cavity.

Referring again to FIGS. 1, 2 and 3 a machining operation of the apparatus (100) is illustrated in accordance with the present invention. The machining operations result in movement of the tool (53).

Movement of the tool (53): When the second driving mechanism drives the second moving plate (50) in Y axis, the second moving plate (50) moves by sliding on the LM rails and causes the spindle (55) to move the tool (53) horizontally in Y axis for machining the job.

When the third driving mechanism drives the third moving plate (60) in Z axis, the third moving plate (60) moves by sliding on the LM rails and causes the spindle (55) to move the tool (53) vertically in Z axis, wherein the tool (53) undergoes downward vertical movement to come in contact with the job and undergoes upward vertical movement to go out of contact from the job. Thus, the tool (53) undergoes linear vertical movement in Z axis as well as linear horizontal movement in Y axis to position over the job and to machine the job.

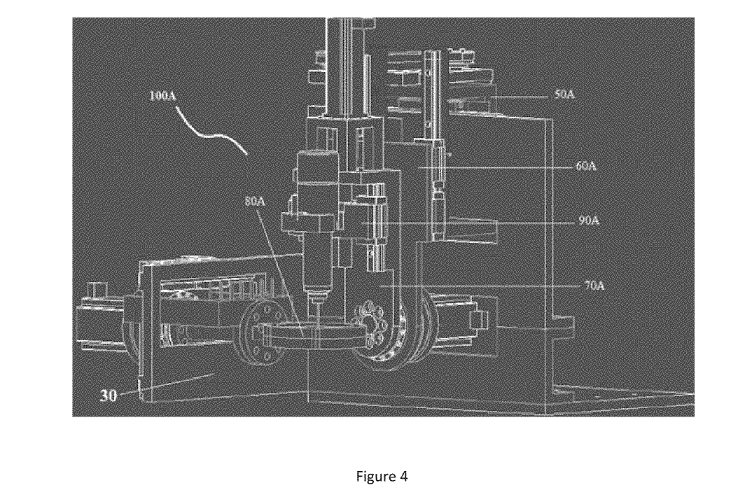

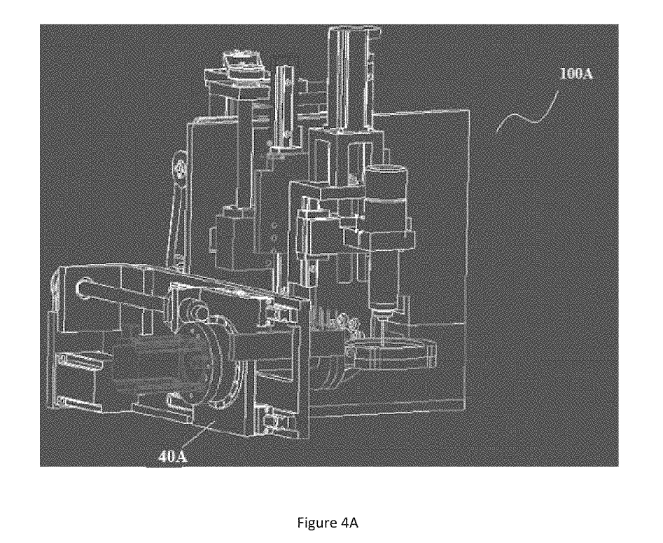

In another aspect, the present invention provides a CNC machining apparatus (100A) as shown in FIGS. 4 and 4A. The CNC machining apparatus (100A) is similar to CNC machining apparatus (100) of FIGS. 1, 2 and 3, except that the orientation of the first moving plate (40A) is changed to 90° as compared to the first moving plate (40) of the CNC machining apparatus (100). The rest of the axes of the CNC machining apparatus (100A) such as, a second moving plate (50A) is configured in Y axis, and the third moving plate (60A) is configured in Z axis. The fourth moving plate (70A) is configured in A axis and is mounted on the third moving plate (60A). The fifth moving plate (80A) is configured on B axis and in turn is mounted on first moving plate (40A). The sixth moving plate (90A) is configured in Z1 axis and is mounted on fourth moving plate (70A). It is evident to those skilled in the art that even the orientation of the first moving plate (40A) is changed, the CNC machining apparatus (100A) provides similar advantages as the CNC machining apparatus (100) and are not described herein again for the sake of the brevity of the invention.

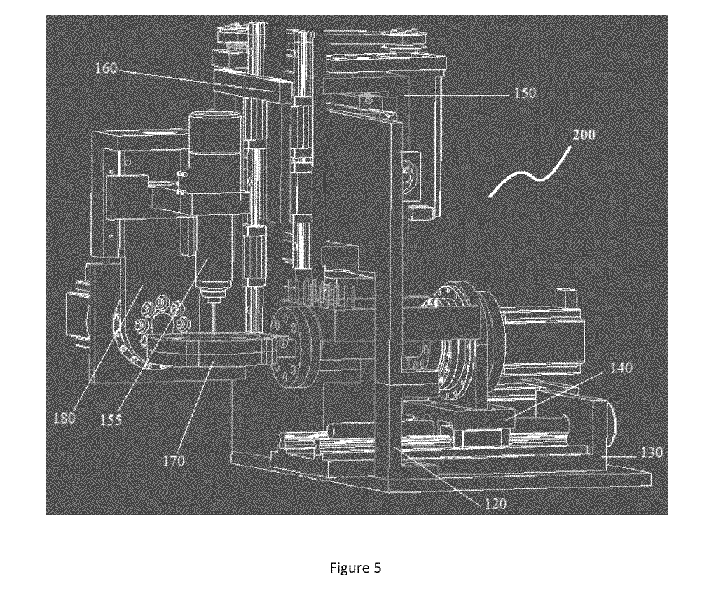

In yet another aspect, the present invention provides a CNC machining apparatus (200) (hereinafter “the apparatus (200)”). Specifically, FIG. 5 shows the apparatus (200). The apparatus (200) is now described in conjunction with apparatus (100) of FIGS. 1, 2 and 3. The apparatus (200) comprises a first moving plate (140) configured in X axis on a stationary base (130), a second moving plate (150) mounted in Y axis on an upper portion (not numbered) of a support member (120). The apparatus (200) further comprises a third moving plate (160) is mounted in Z axis on the second moving plate (150), a fourth moving frame (170) is configured in A axis on the first moving plate (140) that in turn is configured in X axis (140), and a fifth moving frame (180) configured in B axis on the Z axis moving plate (160). In this design of the apparatus (200), the spindle (155) moves vertically up and down, and also swings around the B axis (180) pivot. It may be noted here that the CNC machining apparatus (200) is similar to the CNC machining apparatus (100) except that the CNC machining apparatus (200) does not have sixth moving frame (90) configured in Z1 axis.

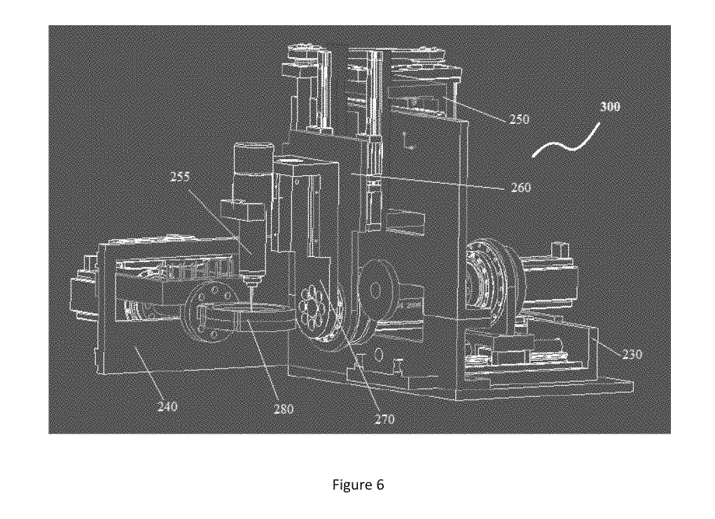

In one more aspect, the present invention provides a CNC machining apparatus (300) (hereinafter “the apparatus (300)”). Specifically, FIG. 6 shows the apparatus (300). The apparatus (300) is now described in conjunction with apparatus (100) of FIGS. 1 2, and 3. The apparatus (300) comprises a first moving plate (240) configured in X axis on a stationary base (230). Specifically, in this embodiment, the orientation of the first moving plate (240) configured in X axis is changed. The apparatus (300) includes a second moving plate (250) mounted in Y axis on an upper portion (not numbered) of a support member. The apparatus (300) further comprises a third moving plate (260) is mounted in Z axis on the second moving plate (250), a fourth moving frame (270) is configured in A axis on the third moving plate (260), and a fifth moving frame (280) configured in B axis on the Z axis moving plate (260). In this design of the apparatus (200), the spindle (255) moves vertically up and down, and also swings around the A axis (280) pivot. It may be noted here that the CNC machining apparatus (300) is similar to the CNC machining apparatus (100A) except that the CNC machining apparatus (300) does not have sixth moving frame (90A) configured in Z1 axis.

### Advantages of the Invention

1. The apparatus (100) is small enough to be easily mountable on a desktop or top of a table.
2. The apparatus (100) comfortably holds the jobs of smaller size.
3. The apparatus (100) allows independent as well as simultaneous control of X, Y, Z, A, B and Z1 axes.
4. The apparatus (100) is cost effective compared to other 5-axis machines.
5. In the apparatus (100), when the tool is machining the job at an angle and if power is lost suddenly, it is possible to remove the machining tool (53) from the job without damaging the job or the tool.

The foregoing objects of the invention are accomplished and the problems and shortcomings associated with prior art techniques and approaches are overcome by the present invention described in the present embodiment. Detailed descriptions of the preferred embodiment are provided herein; however, it is, understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or matter. The embodiments of the invention as described above and the methods disclosed herein will suggest further modification and alterations to those skilled in the art. Such further modifications and alterations may be made without departing from the spirit and scope of the invention.

I claim:

1. A CNC machining apparatus (100) comprising:
a base member (10);
a support member (20) extending vertically from one end of the base member (10);
a stationary base (30) mounted in X axis on top of the base member (10);
a first moving plate (40) configured in X axis on the stationary base (30), the first moving plate (40) capable of being driven by a first driving mechanism;
a second moving plate (50) mounted in Y axis on an upper portion of the support member (20), the second moving plate (20) capable of being driven by a second driving mechanism;
a third moving plate (60) mounted in Z axis on the second moving plate (50), the third moving plate (60) capable of being driven by a third driving mechanism, the third moving plate (60) having a spindle (55) mounted thereon, the spindle (55) includes a cutting tool (53) configured therein;
a fourth moving frame (70) configured in A axis on the first moving plate (40), the fourth moving frame (70) adapted for being driven in response to the movement of the first moving plate (40);
a fifth moving frame (80) configured in B axis on the Z axis moving plate (60);
a sixth moving frame (90) configured in Z1 axis in the B axis plate (80), wherein the spindle moves vertically up and down on Z axis, swings around B axis pivot and also moves up and down in Z1 axis that is mounted on B axis; and
a controller for controlling the movements of the first moving plate (40), the second moving plate (50), the third moving plate (60), the fourth moving frame (70), the fifth moving frame (80) and a sixth moving frame (90).

2. The CNC machining apparatus (100) as claimed in claim 1, wherein the controller is a computer numerical control controller.

3. The CNC machining apparatus (100) as claimed in claim 1, wherein the first moving plate (40), the second moving plate (50) and the third moving plate (60) are configured with any of one linear motion rails, a bush, a dovetail, a roller guide for undergoing smooth rigid motion.

4. The CNC machining apparatus (100) as claimed in claim 1, wherein the driving mechanisms include motors (31, 41, 51, 61 and 71) and a driving unit (34, 44, 54, 64 and 74) connected thereto.

5. The CNC machining apparatus (100) as claimed in claim 1, wherein the motors (31, 41 and 51) are selected from any of a rotary motor and a linear motor.

6. The CNC machining apparatus (100) as claimed in claim 1, wherein the motors (61 and 71) are rotary motors.

7. The CNC machining apparatus (100) as claimed in claim 1, wherein the driving units (34, 44, 54, 64 and 74) are selected from any of a timing belt and pulley, a harmonic drive, a cycloid drive, a worm wheel gear box, a worm wheel and shaft unit.

8. The CNC machining apparatus (100) as claimed in claim 1, wherein the spindle (55) moves vertically up and down on Z axis, swings around B axis pivot and also moves up and down in Z1 axis that is mounted on B axis.

9. The CNC machining apparatus (100), wherein the orientation of the first moving plate (40) configured in X axis is capable of being changed to 90°.
